(19) United States
(12) Patent Application Publication
(10) Pub. No.: US 2013/0206864 A1
(43) Pub. Date: Aug. 15, 2013

(54) PLURAL COMPONENT SPRAYER PREHEATING SYSTEM

(71) Applicants: Timothy P. Kearns, Oklahoma City, OK (US); Casey P. Kearns, Oklahoma City, OK (US)

(72) Inventors: Timothy P. Kearns, Oklahoma City, OK (US); Casey P. Kearns, Oklahoma City, OK (US)

(21) Appl. No.: 13/397,352

(22) Filed: Feb. 15, 2012

(51) Int. Cl. B05B 1/24

(52) U.S. Cl. 239/135

(57) ABSTRACT

A plural component sprayer preheating system has a standard plural component sprayer system having a plurality of pumps for pumping a plurality of components from a plurality of containers into the plural component sprayer system. A component preheating system is attached to the plural component sprayer and has an insulated resin container having a mixer therein for mixing resin in the container. A transfer pump is input from a valve which is coupled to the insulated resin container and to a supply container. The transfer pump has an output into a resin heater so that resin can be pumped either from the insulated container or a supply container through the resin heater and back into the insulated container.

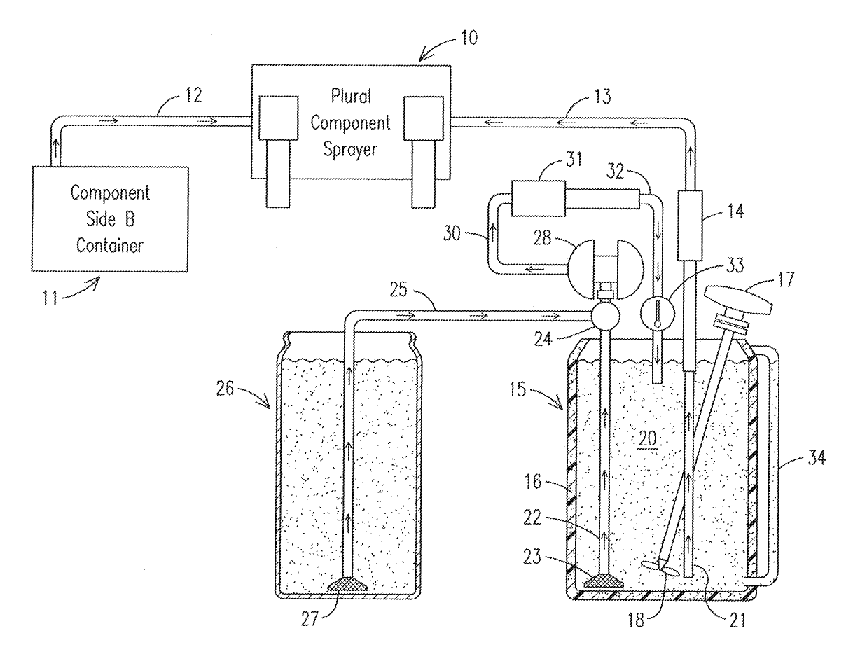

### BACKGROUND OF THE INVENTION

The present invention relates to a plural component sprayer system for mixing and spraying multi-component reactive liquids and especially to a preheating system for operation with existing multi-component sprayer systems.

Multi-component sprayers are commonly used for spraying a variety of materials in which mutually reactive liquids need to be mixed prior to spraying the liquids onto a surface. This is the case in such common techniques as spraying polyurethane foam in place, such as applying insulation. In this procedure, cellular materials are formed by the reaction of any number of components, one of which would be a poly resin component. The pouring or spray mixing of the reactives into a cavity or spraying them onto a surface or screen requires the mixing of the components just prior to spraying them onto a surface or pouring them into a mold. Since the liquids are highly reactive with each other they cannot be mixed together in the apparatus until the last possible moment or else they will react in the apparatus and clog the apparatus. Therefore, the mixture must be injected under pressure and the mutually reactive components must be separately pumped following parallel flow paths for the separate sources of the respected materials of the mixing chamber from which they are injected as they are being mixed. The ratio of the liquids in the mixture that is injected is maintained constant and is closely controlled. It is thus necessary to regulate the quantity of each of the liquids that is pumped to the mixing chamber. For this purpose, proportioning pumps of the reciprocating piston type are often used. The valves of the pumps are arranged to create pumping action when stroked in either direction to provide a continuous flow. The pumps pump the mutually reactive components from supply containers, which supply containers may be 55 gallon drums. A pipe line is inserted directly into a drum for withdrawing the materials into the spray system. The components are typically mixed just prior to the spray gun spraying the mixed components. Some spray systems heat the components just prior to spraying which often results in delays while the materials are being heated prior to using the plural component sprayers.

The present invention provides a preheating system for maintaining the resin component or any of the components that must be in a preheated ready to use state so that when they are pumped into the system as separate components, they are already preheated so that the spraying process can begin immediately and continue on and off as desired without delays.

Prior art plural component sprayers or applicators can be seen in the Gusmer et al., U.S. Pat. No. 3,765,605, for an apparatus for injecting a mixture of mutually reactive liquids, such as the components of a polyurethane foam. In the S.R. Foster, U.S. Pat. No. 2,955,058, a spray application of foamable polyurethane materials is provided. In the Gusmer et al., U.S. Pat. No. 4,199,303, a feeder apparatus for ejecting a mixture of a plurality of liquids is provided for ejecting a mixture of liquids, such as urethane foam. The Hune, U.S. Pat. No. 4,931,249 is for an apparatus and process for mixing and dispensing high viscosity, multiple component reactive liquids into a mold.

Each of these prior patents is directed towards conventional systems for plural component sprayers in which the present invention is added to enhance the operation and supply of the plural components sprayer.

### SUMMARY OF THE INVENTION

A plural component sprayer preheating system attaches to a standard plural component sprayer system and has pumps and connections for pumping components from various containers into the plural component sprayer system. A component preheating system is attached to the plural component sprayer and has an insulated resin container having a mixer therein for mixing resin in the container. A transfer pump is input from a valve which is coupled to the insulated resin container and to a supply container. The transfer pump has an output into a resin heater so that resin can be pumped either from the insulated container or a supply container through the resin heater and into the insulated container. The heated liquid coming into the insulated resin container is continuously mixed with the mixer to maintain the resin in the container in a raised temperature. The plurality component sprayer system supply pump is attached to the insulated resin container for withdrawing the heated resin from the container into the plural component sprayer system so that the resin preheater heats the resin in a plural component spray system. The insulated container may have a sight tube indicating the level of material therein to determine switching the three-way valve between the insulated container and the supply container. The insulated container also has a thermometer mounted thereto for indicating the temperature of the material therein. The insulated container may be insulated with a polymer coating, such as a polyurethane foam coating.

### BRIEF DESCRIPTION OF THE DRAWINGS

Other objects, features, and advantages of the present invention will be apparent from the written description and the drawings in which:

The FIGURE is a diagrammatic view of the plural component sprayer preheating system in accordance with the present invention.

### DETAILED DESCRIPTION OF THE PREFERRED EMBODIMENT

Referring to the drawing, a plural component sprayer preheating system is connected to a standard plural component sprayer 10 which is shown connected on one side to a component container (side A) 11 connected through a feedpipe 12. The resin of the plural component spray system is fed through a line 13 being pumped by a piston pump 14 which is the normal pump for pumping the resin from a 55 gallon drum supply into a plural component sprayer 10. An insulated resin container 15 has a foam insulation 16 which can be a polymer foam, such as a polyurethane foam polymer coating to maintain the insulated container 15 resin materials therein insulated. The insulated container 15 has a mixer (either electric or pneumatic) 17 extending thereinto having an impeller 18 for constantly mixing the resin 20 in the container 15. The resin 20 in the container is withdrawn from the container through a line 21 being pumped by the pump 14 into the plural component sprayer 10. A feed line 22 has a screen end 23 on the end thereof and protrudes into the container 15 and connects to a three-way valve 24. The three way valve also has a connecting line 25 connected into a standard supply container 26 which may be a conventional 55 gallon drum or the like. Line 25 feeds into the bottom of the container where there is a screen 27 for filtering the resin being fed into the line 25. The three-way valve 24 may be switched to feed a transfer pump 28 from either the resin line 22 or the resin line 25 from the supply container 26. When feeding from the line 22, the pump 28 pumps the resin 20 in the container 15 through the pump 28 and through a line 30 and into a preheater 31 where the resin is heated and then fed back through a line 32 into the insulated container 15.

A thermometer 33 measures the temperature of the resin passing through the line 32 back into the insulated container 15. A sight tube 34 is mounted to the insulated container 15 so that the amount of resin 20 in the container 15 can be ascertained by merely looking at the sight tube. When the resin is low, the valve 24 can be switched to the line 25 so that the pump 28 draws liquid from the supply container 26 through the line 25 and pushes the resin through the line 30 and through the heater 31 to heat the resin being fed from the supply drum 26. The heated resin is fed through the line 32 into the insulated container 15 where the mixer 17 continuously mixes the incoming heated resin with the resin remaining in the container. In this way, the resin 20 is continuously heated and mixed until it is withdrawn through the line 21 by the plural component sprayer 10 existing piston pump 14. The resin or other component is thus preheated as it is fed into the sprayer and sprayed onto a surface or into a mold. The plural component sprayer may also have an existing heater for heating the materials and will raise the preheated resin to a higher temperature more rapidly to allow faster spraying and warmup for the plural component sprayer.

It should be clear at this time that a plural component sprayer preheating system has been provided which can be incorporated into most existing plural component sprayers and which enhances the supply by having the plural component sprayer continuously connected to two supply containers.

It should however be clear that the present invention is not to be considered limited to the forms shown which is to be considered illustrative rather than restrictive.

We claim:

1. A plural component sprayer preheating system comprising:
a plural component sprayer system having a plurality of pumps for pumping a plurality of components from a plurality of containers into said plural component sprayer system;
an insulated resin container having a mixer therein for mixing resin in said container;
a transfer pump having an input from said resin container;
a resin heater having an input coupled to said transfer pump for receiving resin pumped from said resin container and an output for outputting the heated resin back into said container;
said resin container having one of said plural component sprayer system pumps attached thereto for pumping heated resin from said container to into said plural component sprayer system;
whereby a resin preheater heats the resin in a plural component spray system.

2. The plural component sprayer preheating system in accordance with claim 1 including a resin supply container positioned adjacent said insulated container.

3. The plural component sprayer preheating system in accordance with claim 2 in which said valve is a three way valve having a pipe connected thereto from said supply container and is switchable to allow said supply resin to be pumped through said pump and through said heater into said insulated container.

4. The plural component sprayer preheating system in accordance with claim 3 in which said insulated container has a site tube thereon indicating the level of material therein.

5. The plural component sprayer preheating system in accordance with claim 4 in said insulated container has a thermometer mounted thereto for indicating the temperature of the material therein.

6. The plural component sprayer preheating system in accordance with claim 5 in which said insulated container is insulated with a polymer coating.

7. The plural component sprayer preheating system in accordance with claim 5 in which said insulated container is insulated with a polyurethane foam coating.
